(19) United States
(12) Patent Application Publication
(10) Pub. No.: US 2013/0057219 A1
(43) Pub. Date: Mar. 7, 2013

(54) POWER SUPPLY APPARATUS FOR VEHICLE AND VEHICLE PROVIDED WITH SAME

(71) Applicant: Hideki SAKATA, Kasai City (JP)

(72) Inventor: Hideki SAKATA, Kasai City (JP)

(73) Assignee: SANYO ELECTRIC CO., LTD., Moriguchi City (JP)

(21) Appl. No.: 13/603,682

(22) Filed: Sep. 5, 2012

(30) Foreign Application Priority Data
Sep. 5, 2011 (JP) 2011-193354

(51) Int. Cl. H02J 7/14

(52) U.S. Cl. 320/118

(57) ABSTRACT

A power supply apparatus comprises a drive battery unit connecting a plurality of batteries in series, a voltage detection circuit, and an equalization circuit for equalizing the batteries of the drive battery unit by discharging the batteries. The equalization circuit has discharge circuits, each of which includes a discharge switch and a discharge resistor connected in series, and also as connects the discharge circuit to the battery via voltage detection lines. The voltage detection circuit has a correction circuit for detecting a correction voltage for a voltage drop in the voltage detection line by switching the discharge switch on with the discharge circuit connected to the battery. In the power supply apparatus, the voltage detection circuit detects the voltage of the battery by correcting the detected voltage of the battery being detected using the correction voltage detected by the correction circuit with the discharge switch in an ON state.

### BACKGROUND OF THE INVENTION

1. Field of the Invention

The present invention relates to a power supply apparatus for vehicles that increases output voltage by connecting a plurality of batteries in series and a vehicle provided with the same.

2. Description of the Related Art

Power supply apparatuses for vehicles increase voltage by connecting a plurality of batteries in series to increase the output. Such power supply apparatuses charge the batteries connected in series with an identical charging current and discharge the batteries with an identical current. Accordingly, if all of the batteries have absolutely identical characteristics, no imbalance occurs in voltages and capacities remaining in the batteries. In reality, however, batteries having identical characteristics cannot be produced. Imbalance in the batteries results in imbalance in voltages and remaining capacities during repeated charging and discharging. The imbalance in the voltages of the batteries further causes specific batteries to be overcharged or to be over-discharged. To prevent such negative effects, a power supply apparatus for vehicles that eliminates the imbalance in batteries by detecting the voltage of each battery has been developed.

See Japanese Published Unexamined Patent Application No. 2007-300701.

JP2007-300701-A discloses a power supply apparatus for vehicles in which a discharge circuit is connected in parallel with each of the batteries of a drive battery unit. The discharge circuit causes a battery having a high voltage to discharge to reduce the voltage, eliminating imbalance in the batteries and equalizing the battery characteristics.

The power supply apparatus for vehicles equalizes the batteries by discharging batteries having higher voltages with an equalization circuit when the vehicle is in a stopped state. The power supply apparatus equalizes the batteries by discharging the batteries having higher voltages only when the vehicle is in a stopped state. The power supply apparatus does not therefore equalize the batteries when the ignition switch is turned on and the vehicle is running. Since time for equalizing the batteries is limited in such power supply apparatuses, the discharge current must be increased to equalize the batteries in a short time A larger discharge current causes greater heat generation due to the Joule heat of discharge resistors. This is because the heat generation due to Joule heat increases in proportion to the square of the discharge current. To increase output voltage, the power supply apparatus for vehicles has a large number of batteries connected in series and equalizes the batteries, leading to a large number of batteries to be equalized. The increased heat generation of the discharge resistors causes the total amount of the heat to increase remarkably. This negative effect can be prevented by increasing the electrical resistance of the discharge resistor and reducing the discharge current. However, taking a long time to equalize the batteries if the discharge current is reduced is a disadvantage.

A power supply apparatus for vehicles can extend the time for equalizing batteries by equalizing the batteries not only when the vehicle is in a stopped state but also when the vehicle is in an operating state. Thus, a power supply apparatus that equalizes the batteries when the vehicle is in an operating state can equalize the batteries while reducing the discharge current of the discharge resistors.

Furthermore, the power supply apparatus for vehicles detects the voltage of each battery using a voltage detection circuit when the ignition switch is switched on and the vehicle is in an operating state. This is because the voltage detection circuit detects the voltage of each battery to determine the state of each battery in the drive battery unit. This power supply apparatus detects the voltage of each battery using the voltage detection circuit and controls the charging and discharging of the drive battery unit, enabling prevention of overcharging and over-discharging of all of the batteries. The input side of the voltage detection circuit is connected to the batteries via voltage detection lines to detect the voltages of the batteries. The voltage detection lines connect the positive and negative terminals of all the batteries to the voltage detection circuit. Leads having a small current capacity, that is, being very thin, or a circuit board is used for the voltage detection lines, because the input impedance of the voltage detection circuit is extremely high. The voltage detection circuit, which has the high input impedance, is connected to the batteries, and can greatly reduce the current in the voltage detection lines. The voltages of the batteries can therefore be detected accurately, ignoring voltage drops in the voltage detection lines. This is because the voltage drops in the voltage detection lines are proportional to the product of the electrical resistance and the current of the voltage detection line.

Incidentally, the equalization circuit is provided with discharge circuits, each of which is provided with a discharge switch and a discharge resistor, but performs equalization by discharging each of the batteries. Therefore, each of the batteries can be discharged to achieve equalization by connecting the discharge circuit to the voltage detection line connected to each battery. In the power supply apparatus, the voltage detection line connecting the voltage detection circuit to each battery can be used jointly as a connection line connecting the equalization circuit to each battery. Accordingly, the voltage detection circuit and the equalization circuit do not need to be connected to the batteries using dedicated connection lines for each, and a simple circuit configuration can be achieved.

In particular, a large number of batteries are connected in series in a power supply apparatus for vehicles; therefore, a large number of voltage detection lines must be provided for detecting voltages of each the batteries. For example, in a power supply apparatus having 100 batteries connected in series, the various batteries must be connected to the voltage detection circuit via 101 voltage detection lines to detect the voltages of the respective batteries. The discharge circuits of the equalization circuit also need to be connected to the various batteries via 101 connection lines to equalize the batteries. As a result, 202 connection lines are required for connections to the batteries in a power supply apparatus in which the voltage detection circuit and the equalization circuit are connected to the batteries by dedicated connection lines.

In a power supply apparatus in which the voltage detection lines for the voltage detection circuit are used as a connection lines for equalization, dedicated connection lines are not required for connecting the discharge circuit of the equalization circuit to the batteries, making remarkable simplification of the circuit configuration possible. This power supply apparatus is characterized by the simplification of the connection lines, but a disadvantage is not being able to detect the voltages of each of the batteries accurately detected during an operating state. The cause is the equalization circuit changing the voltage drops in the voltage detection lines, causing errors in detecting voltages of the batteries.

When a discharge switch for the equalization circuit is in an ON state, a discharge current flowing through the voltage detection line causes a voltage drop corresponding to the product of the electrical resistance and the discharge current in the voltage detection line. The voltage drop in the voltage detection line results in an error in the voltage of the battery detected at the voltage detection circuit. This is because the voltage of the battery is detected as being lower than actual values because of the voltage drop. The voltage drop is never constant because the voltage drop does not occur in a state where the discharge switch is turned off and the discharge current does not flow.

Accordingly, the voltages of the batteries detected by the voltage detection circuit change according to the ON state and the OFF state of the discharge switch.

The power supply apparatus for vehicles can determine the state of each battery with greater precision by accurately detecting the voltage of each battery. Thus, charging and discharging can be carried out, while effectively preventing deterioration of all the batteries. More precisely detecting the voltages of the batteries is required in a power supply apparatus that uses lithium ion batteries or lithium polymer batteries for the drive battery unit.

An object of the present invention is to provide a power supply apparatus for vehicles and a vehicle provided with the same in which a simple circuit configuration of the equalization circuit is achieved using voltage detection lines for detecting the voltages of batteries as connection lines for the equalization circuit, and further, the discharge current for equalization can be reduced by equalizing the batteries when the vehicle is in an operating state, thereby making equalization of the batteries possible; furthermore, the voltages of the batteries can be detected with extremely high precision during the equalization.

### SUMMARY OF THE INVENTION

A power supply apparatus for vehicles according to the present invention is provided with: a drive battery unit obtained by connecting, in series, a plurality of chargeable batteries supplying electric power to a motor driving a vehicle; a voltage detection circuit connected to each of the batteries of the drive battery unit via a voltage detection line and detecting the voltage of each of the batteries; and an equalization circuit that equalizes the batteries of the drive battery unit by discharging the various batteries. The equalization circuit is provided with a discharge circuit that is provided with a discharge switch and a discharge resistor connected in series, and the discharge circuit is connected to a battery via a voltage detection line. The voltage detection circuit is provided with a correction circuit that detects a correction voltage for the voltage drop in the voltage detection line with the discharge circuit connected to the battery by switching the discharge switch on. In the power supply apparatus, the voltage detection circuit detects voltages of the batteries as the detected voltages of the detected batteries corrected by the correction voltages detected by the correction circuit with the discharge switches in an ON state.

Since the voltage detection lines for detecting the voltages of the batteries are used jointly as the connection lines for the equalization circuit in the power supply apparatus above, the equalization circuit can have a simple circuit configuration. Since the voltage detection lines for detecting the voltages of the batteries are used as the connection lines, a dedicated connection line is not required for connecting each of the discharge circuits, which includes a discharge switch and a discharge resistor, to a battery.

Further, the power supply apparatus above can detect the voltages of the batteries with extremely high precision, while equalizing the batteries not only in the OFF state of the ignition switch but also in a state of vehicle operation. Since the batteries are equalized when the vehicle is in an operating state, the voltages of the batteries can be accurately detected even when the discharge switch is switched on or off. This characteristic can be achieved by detecting the voltage drop in the voltage detection line that arises in the ON state of the discharge switch as a correction voltage, and by correcting the voltage of the battery being detected by the correction voltage.

Furthermore, the above power supply apparatus can equalize the batteries when the vehicle is in an operating state, thereby increasing a time period for equalizing the batteries. Thus, the batteries can be equalized, while the discharge current for equalizing the batteries is reduced. This is very important for equalizing a plurality of batteries in a drive battery unit. This is because, increasing the discharge current for equalizing the batteries increases the amount of heat in the discharge resistors, and therefore, the plurality of discharge resistors generate heat when a large number of batteries are discharged, leading to an extremely large amount of total. Reducing the amount of heat in the discharge resistors can allow for discharge resistors with a very low resistance, allowing for the characteristic of a large number of discharge resistors being provided in small space.

In the power supply apparatus for vehicles according to the present invention, the battery detected at the voltage detection circuit may be one secondary battery cell or a plurality of secondary battery cells connected in series.

In the power supply apparatus for vehicles according to the present invention, the voltage detection circuit is provided with a detection circuit that detects the ON state of the ignition switch of the vehicle; the detection circuit detects the ON state of the ignition switch, allowing the correction circuit to detect the voltage drop in the voltage detection line.

The power supply apparatus above corrects a voltage of the detected battery by detecting a voltage drop in the voltage detection line every time the ignition switch is switched on. The voltages of the batteries can therefore be accurately detected even when an electrical resistance of the voltage detection line changes with time.

In the power supply apparatus for vehicles according to the present invention, the voltage detection circuit is provided with a contactor detection circuit that detects the OFF state of a contactor connecting the drive battery unit to a load on the vehicle side: the contactor detection circuit detects the OFF state of the contactor, allowing the correction circuit to detect the correction voltage.

The power supply apparatus above detects a voltage drop in the voltage detection line, or a correction voltage in the OFF state of the contactor, that is, in the state of the drive battery unit not being discharged. Voltages of the plurality of the batteries can therefore be detected accurately.

In the power supply apparatus for vehicles according to the present invention, the equalization circuit is provided with a control circuit controlling the turning ON and OFF of the discharge switch after the voltage for each of the batteries is detected; the control circuit makes the ON and OFF connections for the discharge switch, allowing the respective batteries to be equalized.

In the power supply apparatus for vehicles according to the present invention, the voltage detection line can connect the voltage detection circuit to each of the batteries via a lead and a connector.

The power supply apparatus above can accurately detect the voltages of the batteries while detecting the voltage drop in the lead and the connector.

In the power supply apparatus for vehicles according to the present invention, the voltage detection circuit can determine a failure in the voltage detection line by comparing the voltage drop in the voltage detection line detected at the correction circuit with an established voltage.

The power supply apparatus for vehicles above can determine a failure in the voltage detection line occurring over time by making the correction circuit detect the correction voltage.

A vehicle according to the present invention has any of the power supply apparatuses above.

### BRIEF DESCRIPTION OF THE DRAWINGS

FIG. 1 is a block diagram of a power supply apparatus for vehicles according to an embodiment of the present invention;

FIG. 2 is an equivalent circuit diagram of a circuit for detecting the voltages of batteries in the power supply apparatus for vehicles shown in FIG. 1;

FIG. 3 is a flow chart showing an operation for detecting the voltages of the batteries in the power supply apparatus for vehicles according the embodiment of the present invention;

FIG. 4 is a block diagram showing an example in which a power supply apparatus is mounted in a hybrid automobile driven by an engine and a motor; and

FIG. 5 is a block diagram showing an example in which a power supply apparatus is mounted in an electric automobile exclusively driven by a motor.

### DETAILED DESCRIPTION OF THE EMBODIMENT(S)

Hereinafter, an embodiment of the present invention is described based on the drawings. Note that the embodiment given below is to exemplify the power supply apparatus for vehicles and vehicle provided with the same for making a technical concept of the present invention more specific, and therefore, a power supply apparatus for vehicles and a vehicle provided with the same according to the present invention is not limited to the following.

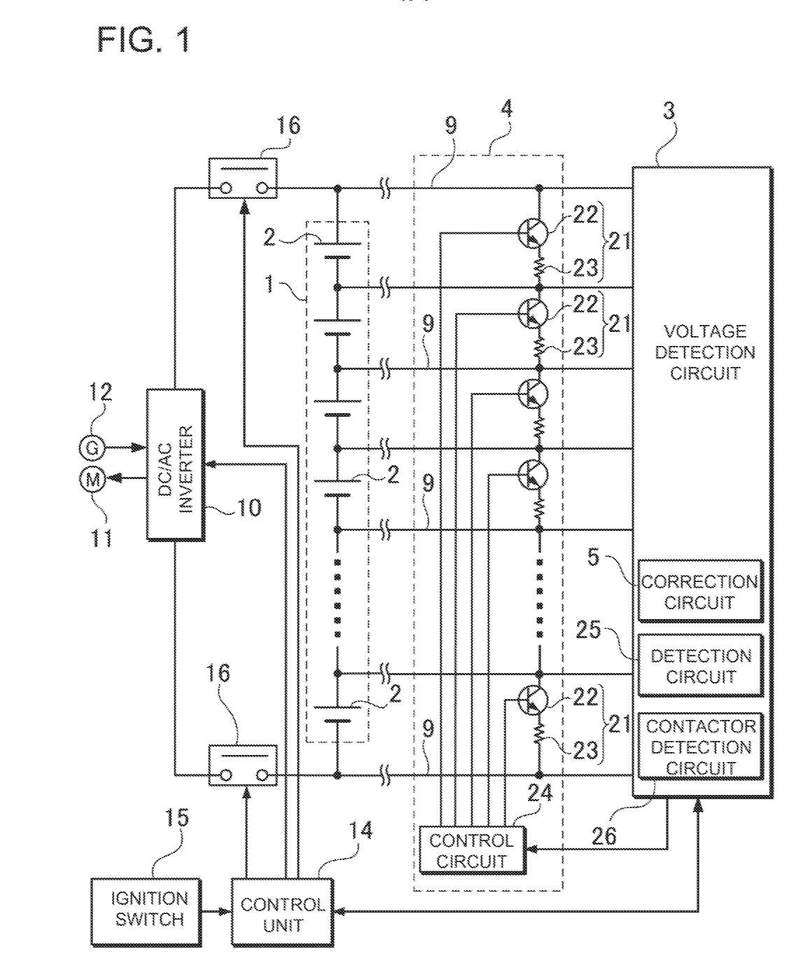

As shown in the block diagram in FIG. 1, a power supply apparatus for vehicles has a drive battery unit 1 obtained by connecting, in series, a plurality of chargeable batteries 2 supplying electric power to a motor 11 that drives a vehicle, a voltage detection circuit 3, which is connected to the batteries 2 of the drive battery unit 1 via voltage detection lines 9 and detects the voltages of the batteries 2, and an equalization circuit 4 that equalizes the batteries 2 of the drive battery unit 1 by discharging the batteries 2.

The power supply apparatus shown in the block diagram in FIG. 1 further has contactors 16 connected to an output side of the drive battery unit 1. The drive battery unit 1 is connected to a DC/AC inverter 10 for a load on the vehicle side via the contactors 16. The DC/AC inverter 10 is connected to the motor 11 that drives the vehicle and a generator 12 that charges the drive battery unit 1. A control unit 14 controls the DC/AC inverter 10. The control unit 14 supplies electric power of the drive battery unit 1 to the drive motor 11 via the DC/AC inverter 10, causing the motor 11 to drive the vehicle. The control unit 14 also controls the generator 12 to cause the generator 12 to charge the drive battery unit 1.

Further, an ignition switch 15 is connected to the control unit 14. A signal input from the ignition switch 15 switches the contactor 16 on or off. When the ignition switch 15 is switched on, the control unit 14 switches the contactor 16 on. After the ignition switch 15 is switched on and an initial operational check is completed, the control unit 14 switches the contactor 16 from off to on and connects the drive battery unit 1 to the DC/AC inverter 10. When the ignition switch 15 is switched off, the control unit 14 switches the contactor 16 off and cuts the drive battery unit 1 off from the DC/AC inverter 10.

The battery 2 of the drive battery unit 1 is one secondary battery cell or a plurality of secondary battery cells connected in series. The battery 2 of the drive battery unit 1 is a lithium ion battery cell or a lithium polymer battery cell. The drive battery unit 1 in which the secondary battery cells are lithium ion battery cells or lithium polymer battery cells constitute a single secondary battery from batteries 2. This power supply apparatus detects voltages of the batteries 2 using the voltage detection circuit 3 and equalizes the batteries 2 using the equalization circuit 4. However, the batteries may be any type of chargeable secondary battery cell, such as a nickel metal hydride battery cells. In a power supply apparatus using nickel metal hydride battery cells for the batteries, the plurality of secondary battery cells is connected in series to obtain one battery, and the voltage of each battery, that is, those made into the battery connecting the plurality of secondary battery cells in series, is detected, and the batteries are equalized.

The input side of the voltage detection circuit 3 is connected to positive and negative terminals of the batteries 2 via the voltage detection lines 9. The voltage detection circuit 3 detects voltages of the batteries 2 via the voltage detection lines 9. The voltage detection circuit 3 also has a correction circuit 5 that corrects the voltage to be detected. The correction circuit 5 corrects the voltage to be detected by turning a discharge switch 22 of the equalization circuit 4 described later on and off, so that correct voltages can be detected for the batteries 2.

The equalization circuit 4 equalizes the voltages of the batteries 2 to eliminate imbalance, achieving the equalization. The equalization circuit 4 detects the voltages of each of the batteries 2 to eliminate imbalance in the voltages of the batteries 2 and achieve the equalization. The equalization circuit 4 equalizes the batteries 2 not only in the ON state for the ignition switch 15, that is, a state of the vehicle being able to operate, but also in the OFF state for the ignition switch 15, that is, in a state of the vehicle not being able to operate. Note that the equalization circuit 4 operation terminates after all of the batteries 2 are equalized.

As shown in FIG. 1, the equalization circuit 4 discharges a battery 2 that has a high voltage using a discharge resistor 23 to eliminate the imbalance. The equalization circuit 4 shown in the figure has discharge circuits 21, each of which connects a discharge switch 22 to a discharge resistor 23 in series, and a control circuit 24 controlling the turning on and off of the discharge switch 22. Each of the discharge circuits 21 discharges a respective battery 2 independently for equalization. Therefore, the same number of discharge circuits 21 as batteries 2 is provided. For example, 100 discharge circuits are provided in a power supply apparatus having 100 batteries connected in series. The discharge switch 22 and the discharge resistor 23 for each discharge circuit 21 are mounted on a circuit board (not shown) and connected to the respective battery 2 via the voltage detection line 9 for the voltage detection circuit 3.

The equalization circuit 4 is provided with the control circuit 24 for controlling the turning on and off of the discharge switches 22 according to the voltages of the batteries 2. The control circuit 24 in FIG. 1 controls the turning on and off of each of the discharge switches 22 according to voltages of the batteries 2 detected by the voltage detection circuit 3. The equalization circuit 4 also uses the voltage detection circuit 3 as a circuit for detecting the voltages of the batteries 2. The equalization circuit 4, however, can be provided with a dedicated voltage detection circuit for detecting the voltages of the batteries.

The control circuit 24 compares the voltages of the batteries 2 detected by the voltage detection circuit 3, and controls the discharge switches 22 so that voltages of all of the batteries 2 are equalized. The control circuit 24 switches on the discharge switch 22 of the discharge circuit 21 connected to a battery 2 having a high voltage, causing the battery 2 to discharge. As the battery 2 discharges, the voltage thereof decreases. When the voltage of the battery 2 decreases to be in balance with voltages of the other batteries 2, the discharge switch 22 is switched from on to off. When the discharge switch 22 is turned off, the discharging of the battery 2 is terminated. The control circuit 24 discharges batteries 2 having high voltages to balance the voltages of all of the batteries 2 in this manner.

The equalization circuit 4 equalizes the batteries 2 not only in the ON state for the ignition switch 15 but also in the OFF state thereof. In the power supply apparatus in FIG. 1, the discharge circuits 21 of the equalization circuit 4 are connected to the respective batteries 2 via the voltage detection lines 9 that connect the voltage detection circuit 3 to the batteries 2. Accordingly, when the voltage detection circuit 3 detects the voltages of the batteries 2, discharge switches 22 connected to some batteries 2 are in the ON state, while discharge switches 22 connected to other batteries 2 are in the OFF state. With the discharge switch 22 in the ON state, a discharge current flowing via the discharge resistor 23 causes a voltage drop in the voltage detection line 9. On the other hand, with the discharge switch 22 in the OFF state, the voltage drop does not occur in the voltage detection line 9 because the discharge current does not flow. When the voltage detection circuit 3 detects the voltages of the batteries 2, the voltage drop in the voltage detection line 9 therefore changes depending on the ON or OFF state of the discharge switch 22, and an error arises in the in voltages being detected.

To solve this problem and always cause the voltage detection circuit 3 to accurately detect the voltages of the batteries, the voltage detection circuit 3 is provided with the correction circuit 5 in the power supply apparatus for vehicles in FIG. 1. The correction circuit 5 switches the discharge switch 22 on to detect a correction voltage for the voltage drop in the voltage detection line 9 with the discharge circuit 21 connected to the battery 2. The correction circuit 5 can detect the voltage drop by subtracting an ON-voltage detected with the discharge switch 22 in the ON state from an OFF-voltage detected with the discharge switch 22 in the OFF state. The voltage drop in the voltage detection line 9 does not occur with the discharge switch 22 in the OFF state, while the voltage drop occurs in the voltage detection line 9 with the discharge switch 22 in the ON state. The voltage drop can therefore be detected from the difference in the voltages.

The correction circuit 5 switches the discharge switch 22 on or off according to the timing when the ignition switch 15 of the vehicle is switched on and an initial operational check is performed. The correction voltage for the voltage drop in the voltage detection line 9 is then detected according to the difference in the voltages. According to the timing when the ignition switch 15 is switched on and the initial operational check is performed, the contactor 16 is in the OFF state and the drive battery unit 1 is not charged and discharged. The voltage of each of the batteries 2 become stable and do not change, allowing the correction circuit 5 to more accurately detect the correction voltage. Even in the case with the contactor 16 in the ON state where the drive battery unit 1 is connected to a load and being charged or discharged, the correction voltage can be detected by switching the discharge switch 22 on or off in a state with a current for charging or discharging the drive battery unit 1 that is smaller than a set value. This is because the voltage variation in a battery 2 can be almost negligible when the current of the drive battery unit 1 is smaller than the set value.

The voltage detection circuit 3 shown in FIG. 1 is provided with a detection circuit 25 for detecting the ON state of the ignition switch 15. In the voltage detection circuit 3, the detection circuit 25 can detect that the ignition switch 15 is switched on, and the correction circuit 5 can detect a voltage drop in the voltage detection lines 9. The voltage detection circuit 3 can detect the voltage drops in the voltage detection lines 9, for example, every time the ignition switch 15 is switched on, and can correct detected voltages of the batteries 2. The voltage detection circuit 3 shown in the figure further has a contactor detection circuit 26 for detecting the OFF state of the contactor 16 that connects the drive battery unit 1 to the load on the vehicle side. In the voltage detection circuit 3, the contactor detection circuit 26 can detect that the contactor 16 is switched off, and the correction circuit 5 can detect the correction voltages. The voltage detection circuit 3 detects the OFF state of the contactor 16 to detect the voltage drop in the voltage detection line 9. This enables to accurately detect the voltages of the batteries 2 when the drive battery unit 1 is not being discharged.

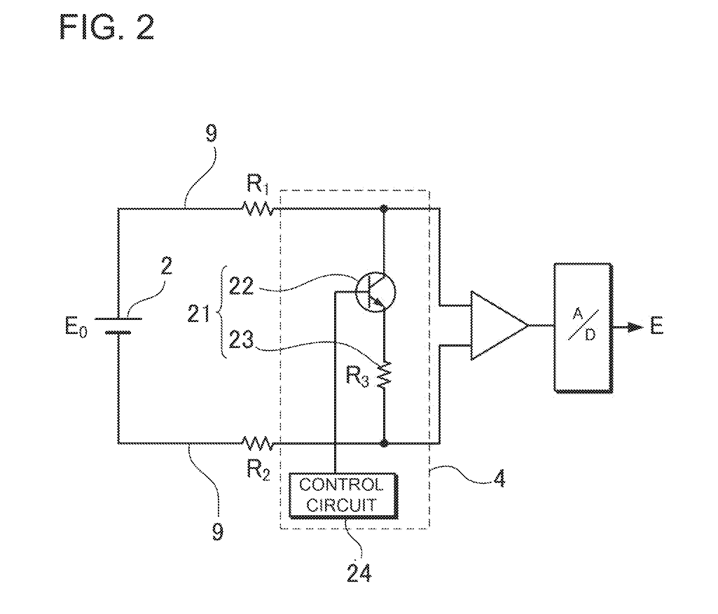

The correction circuit 5 detects the voltage drops in the voltage detection lines 9 for detecting the voltage of each battery 2, that is, a correction voltage for each battery 2 by switching each of the discharge switches 22 on or off. As shown in FIG. 2, the voltage detection line 9 has electric resistances R₁ and R₂ because of the electrical resistance of a lead and contact resistance of a connector. When current flows through the electrical resistances R₁ and R₂, a voltage drop occurs. This voltage drop corresponds to a product of the resistance of the electrical resistances R₁, R₂ and the current flowing. Since a discharge current does not flow through the voltage detection line 9 in the OFF state of the discharge switch 22, the voltage drop due to the electrical resistances R₁ and R₂ of the voltage detection line 9 does not occur. More specifically, the current flowing through an input side of the voltage detection circuit 3 generates a slight voltage drop due to the electrical resistances R₁ and R₂ of the voltage detection line 9. However, the input impedance of the voltage detection circuit 3 is extremely large, and the voltage drop is negligibly small. The voltage drop in the voltage detection line 9, therefore, becomes 0V in the OFF state of the discharge switch 22. As a result, the voltage detection circuit 3 accurately detects a voltage (E₀) of the battery 2 in this state.

On the other hand, when the discharge switch 22 is switched on to discharge the battery 2 via the voltage detection line 9, a voltage drop, which corresponds to a product of the discharge current and the electrical resistances R₁, R₂ in the voltage detection line 9, occurs. A detected voltage (E) is therefore obtained in the voltage detection circuit 3 by subtracting a voltage (E₁) for the voltage drop from the voltage (E₀) of the battery 2. The detected voltage (E) is as follows.

E=E₀−E₁

The voltage (E₀) of the battery 2 where a voltage drop does not occur in the voltage detection line 9 is detected in the OFF state of the discharge switch 22. Accordingly, the voltage drop (E₁) in the voltage detection line 9 is detected by subtracting the voltage detected in the ON state of the discharge switch 22 from the voltage detected in the OFF state of the discharge switch 22.

The correction circuit 5 switches the discharge switches 22 on or off and detects, from the voltages of all of the batteries 2, a voltage drop for a correction voltage in a state where the voltages of all of the batteries 2 are detected. The correction voltage is stored in a memory for the voltage detection circuit 3. The voltage detection circuit 3 accurately detects the voltage of the battery by correcting the voltage detected for the detected battery 2 using the stored correction voltage. That is, when the voltage detection circuit 3 detects the voltage of the battery 2 connected in parallel with the discharge switch 22 in the ON state, the correction voltage added to the detected voltage is set as the voltage of the battery 2. When the voltage detection circuit 3 detects the voltage of the battery 2 connected in parallel with the discharge switch 22 in the OFF state, the voltage of each battery 2 can be accurately detected with the detected voltage as the voltage for the battery 2. The control circuit 24 in the equalization circuit 4 controls the turning on and off of the discharge switch 22. The voltage detection circuit 3 can therefore determine whether the correction voltage is added to the detected voltage or not by an on or off signal for the discharge switch 22 input from the control circuit 24, thereby achieving a correct detection of the voltage for each battery 2.

The voltage detection circuit 3 can further determine a failure in a voltage detection line 9 by comparing the voltage drop in the voltage detection line 9 detected at the correction circuit 5 with a set voltage. In a voltage detection line 9 that comprises a lead and a connector, the electrical resistance increases due to damage to the lead, loose contact of the connector, or the like. The voltage detection circuit 3 can therefore determine the failure of the voltage detection line 9 when the voltage drop in the voltage detection line 9 detected by the correction circuit 5 becomes larger than the set voltage. This allows rapid detection a failure in the voltage detection line 9 occurring over time, and improves safety of the apparatus.

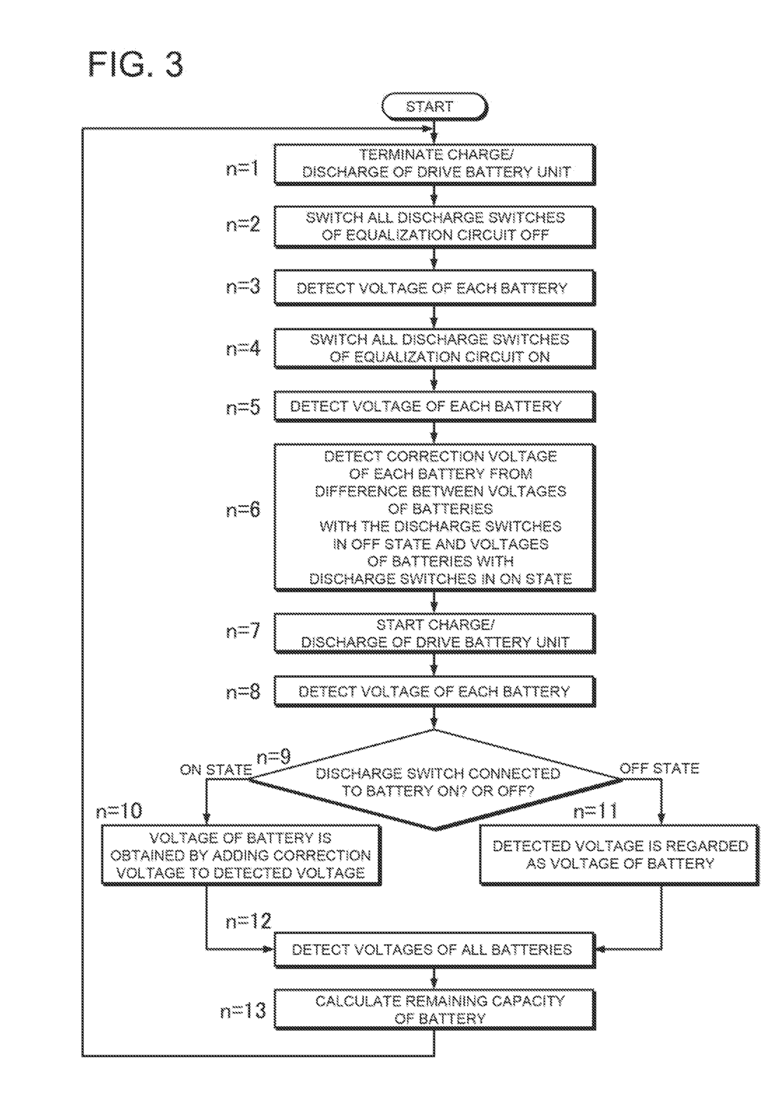

As shown in the flow chart in FIG. 3, the power supply apparatus for vehicles above accurately detects voltages of the batteries 2, while equalizing the batteries 2 of the drive battery unit 1 according the following operations.

(Step n=1)

Charging and discharging of the drive battery unit 1 is terminated by switching the contactor 16 off.

(Step n=2)

All of the discharge switches 22 in the equalization circuit 4 are switched off.

(Step n=3)

The voltage detection circuit 3 detects the voltages of the batteries 2.

(Step n=4)

All of the discharge switches 22 in the equalization circuit 4 are switched on.

(Step n=5)

The voltage detection circuit 3 detects the voltages of the batteries 2.

(Step n=6)

The correction circuit 5 detects, a voltage drop in the voltage detection line 9 that detects the voltage of each battery 2, that is, a correction voltage for each battery 2 from a difference between the voltage of the battery detected in step n=3 with the discharge switch 22 in the OFF state and the voltage of the battery detected in step n=5 with the discharge switch 22 in the ON state, and then stores the correction voltages in the memory.

(Step n=7)

Charging and discharging of the drive battery unit 1 is started by switching the contactor 16 on.

(Steps n=8 to 12)

The voltage detection circuit 3 detects a voltage for each battery 2. At this time, the voltage detection circuit 3 detects whether the discharge switch 22 connected in parallel with the battery 2 for which the voltage is being detected is on or off. When the connected discharge switch 22 is in the ON state, the voltage of the battery 2 is the correction voltage added to the detected voltage (step n=10). On the other hand, when the connected discharge switch 22 is in the OFF state, the detected voltage for the battery 2 is the voltage of the battery 2 (step n=11).

The voltages for all the batteries 2 are detected as per the above.

(Step n=13)

The remaining capacity of each battery 2 is calculated from the detected voltage of the battery. Thereafter, the operation returns to step n=1.

The power supply apparatus above can be used as a vehicle-mounted power source. Vehicles having the power source mounted therein can be used as hybrid automobiles or plug-in hybrid automobiles driven by both an engine and a motor, or electric vehicles exclusively driven by a motor. The power supply apparatus above can be used for power sources in these vehicles.

(Power Supply Apparatus for Hybrid Vehicles)

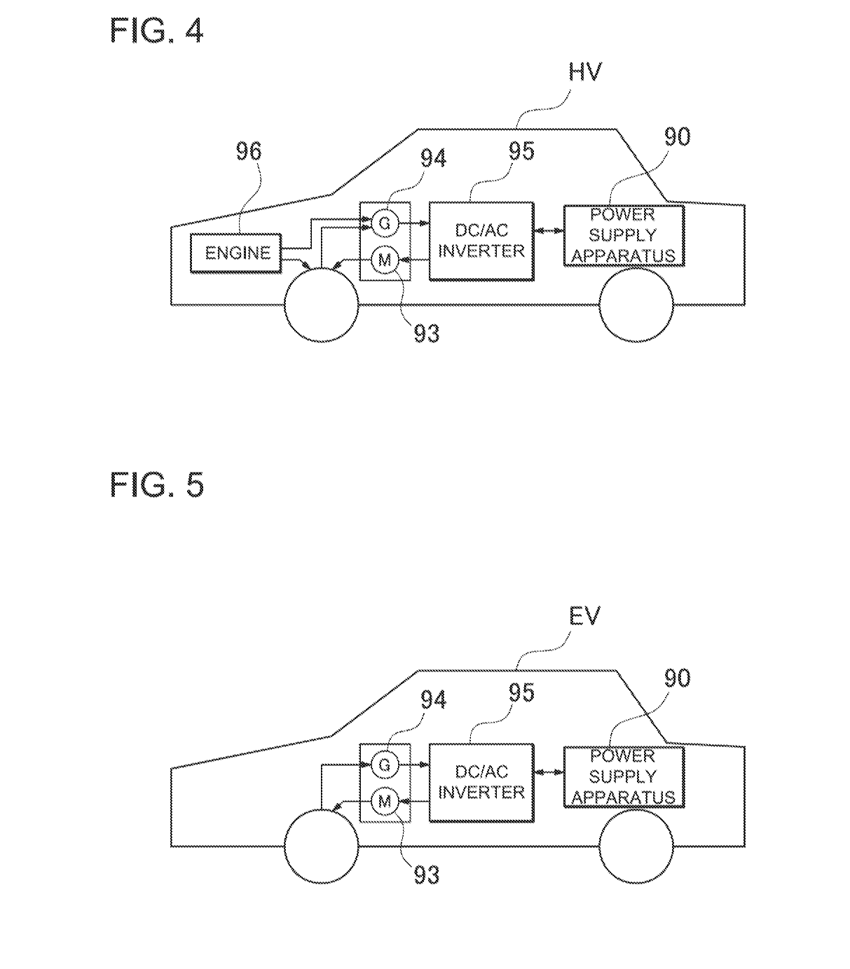

FIG. 4 shows an example in which a power supply apparatus is mounted in a hybrid automobile driven by both an engine and a motor. A vehicle HV having a power supply apparatus 90 shown in the figure mounted therein is provided with an engine 96 and a drive motor 93 for driving the vehicle HV, the power supply apparatus 90 for supplying electric power to the motor 93, and a generator 94 for charging a battery for the power supply apparatus 90. The power supply apparatus 90 is connected to the motor 93 and the generator 94 via a DC/AC inverter 95. The vehicle HV is driven by both the motor 93 and the engine 96 while the battery for the power supply apparatus 90 is charged and discharged. The motor 93 is driven to drive the vehicle in ranges of low efficiency for the engine, for example, during acceleration or driving at a low speeds. The motor 93 is driven by electric power supplied by the power supply apparatus 90. The generator 94 is driven by the engine 96 or regenerating braking to charge the battery for the power supply apparatus 90 during braking of the vehicle.

(Power Supply Apparatus for Electric Automobiles)

FIG. 5 shows an example in which a power supply apparatus is mounted in an electric automobile exclusively driven by a motor. A vehicle EV having a power supply apparatus 90 shown in the figure mounted therein is provided with a drive motor 93 for driving the vehicle EV, the power supply apparatus 90 for supplying electric power to the motor 93, and a generator 94 for charging a battery of the power supply apparatus 90. The power supply apparatus 90 is connected to the motor 93 and the generator 94 via a DC/AC inverter 95. The motor 93 is driven by electric power supplied by the power supply apparatus 90. The generator 94 is driven by energy during regenerating braking of the vehicle EV to charge the battery for the power supply apparatus 90.

### INDUSTRIAL APPLICABILITY

The power supply apparatus according to the present invention can be suitably used as a power supply apparatus for vehicles such as plug-in hybrid automobiles or hybrid automobiles capable of switching between an EV drive mode and an HEV drive mode, or electric automobiles.

It should be apparent to those with ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2011-193,354 filed in Japan on Sep. 5, 2011, the content of which is incorporated herein by reference.

What is claimed is:

1. A power supply apparatus for vehicles comprising:
a drive battery unit obtained by connecting, in series, a plurality of chargeable batteries for supplying electric power to a motor that drives a vehicle;
a voltage detection circuit connected to each of the batteries of the drive battery unit via a voltage detection line for detecting a voltage of each of the batteries; and
an equalization circuit for equalizing the batteries of the drive battery unit by discharging the each of the batteries,
wherein the equalization circuit comprises discharge circuits provided with discharge switch and a discharge resistor connected in series, and the discharge circuits are connected to the batteries via the voltage detection lines,
wherein the voltage detection circuit comprises a correction circuit for detecting a correction voltage for a voltage drop in a voltage detection line with the discharge circuit connected to a battery by switching a discharge switch on, and
wherein the voltage detection circuit detects a voltage for the battery by correcting a detected voltage for the battery being detected using the correction voltage detected by the correction circuit with the discharge switch in the ON state.

2. The power supply apparatus for vehicles according to claim 1, wherein the battery detected by the voltage detection circuit includes one secondary battery cell or a plurality of secondary battery cells connected in series.

3. The power supply apparatus for vehicles according to claim 1, wherein the voltage detection circuit comprises a detection circuit detecting an ON state of an ignition switch for the vehicle, and the detection circuit detects the ON state of the ignition switch, allowing the correction circuit to detect the voltage drop in the voltage detection line.

4. The power supply apparatus for vehicles according to claim 1, wherein the voltage detection circuit comprises a contactor detection circuit for detecting an OFF state of a contactor that connects the drive battery unit to a load on the vehicle side, and the contactor detection circuit detects the OFF state of the contactor, allowing the correction circuit to detect the correction voltage.

5. The power supply apparatus for vehicles according to claim 1, wherein the equalization circuit comprises a control circuit for controlling the turning on and off of the discharge switch after a voltage is detected for each of the batteries, and the control circuit controls the turning on and off of the discharge switch, allowing each of the batteries to be equalized.

6. The power supply apparatus for vehicles according to claim 1, wherein the voltage detection line can connect the voltage detection circuit to each of the batteries via a lead and a connector.

7. The power supply apparatus for vehicles according to claim 1, wherein the voltage detection circuit can determine a failure of the voltage detection line by comparing the voltage drop in the voltage detection line detected at the correction circuit with a set voltage.

8. A vehicle provided with the power supply apparatus according to claim 1.
